(19) United States
(12) Patent Application Publication
(10) Pub. No.: US 2025/0189018 A1
(43) Pub. Date: Jun. 12, 2025

(54) BELT-TYPE ACTUATOR ASSEMBLY HAVING MOTOR HOUSING COVER TO WHICH IDLER IS FIXED

(71) Applicant: HL MANDO CORPORATION, Gyeonggi-do (KR)

(72) Inventors: Troy STRIETER, Bay City, MI (US); Joshua GROVE, Bay City, MI (US); Katelyn ENGELHARDT, Bay City, MI (US)

(21) Appl. No.: 18/533,026

(22) Filed: Dec. 7, 2023

(51) Int. Cl. F16H 19/08; B60T 13/74; F16D 65/18; F16D 121/24; F16D 125/40; F16D 125/44; F16H 57/031; F16H 57/035

(52) U.S. Cl. CPC F16H 19/08; B60T 13/746; F16D 65/18; F16H 57/031; F16H 57/035; F16D 2121/24; F16D 2125/40; F16D 2125/44; F16H 2019/085

(57) ABSTRACT

An actuator assembly may comprise: a motor having a motor shaft; and a motor housing comprising a housing body accommodating at least a part of the motor and a housing cover coupled to the housing body, wherein an idler configured to tension a drive belt rotatably coupled to the motor shaft. The actuator assembly further comprises one or more couplers configured to allow the housing cover to be movable or rotatable relative to the housing body such that the idler fixed to the housing cover is movable or rotatable according to movement or rotation of the housing cover to adjust tension of the drive belt.

### TECHNICAL FIELD

Some embodiments of the present disclosure generally relate to an actuator assembly having a belt mechanism, in particular, to a belt-type actuator assembly having a motor housing cover with one or more slots for adjusting a location of an idler.

### BACKGROUND

A belt drive system has a belt which is a loop of flexible material used to link two or more rotating shafts mechanically, most often parallel. Belts may be used as a source of motion, to transmit power efficiently or to track relative movement. Belts are looped over pulleys and may have a twist between the pulleys, and the shafts need not be parallel. The belt drive system can also be used to change the speed of rotation and torque, either up or down, by using different sized pulleys.

In the belt drive system, an idler is often used to press against a belt of a pulley in order to increase the torque and wrap angle and thus contact area of the belt against the pulley, increasing the force transfer capacity. For example, conventional belt drive systems commonly incorporate one movable pulley which is spring-or gravity-loaded to act as a belt tensioner, to accommodate stretching of the belt due to temperature or wear. An idler pulley is usually used for this purpose, in order to avoid having to move the power-transfer shafts.

It would be desirable to have an apparatus and method that take into account some of the issues discussed above, as well as other possible issues.

### SUMMARY

The features and advantages of the present disclosure will be more readily understood and apparent from the following detailed description, which should be read in conjunction with the accompanying drawings, and from the claims which are appended to the end of the detailed description.

According to an embodiment of the present disclosure, an actuator assembly may comprise: a motor having a motor shaft; and a motor housing comprising a housing body accommodating at least a part of the motor and a housing cover coupled to the housing body, wherein an idler configured to tension a drive belt rotatably coupled to the motor shaft is fixed to the housing cover having a hole for passing through the motor shaft.

The actuator assembly may further comprise one or more couplers configured to allow the housing cover to be movable or rotatable relative to the housing body such that the idler fixed to the housing cover is movable or rotatable according to movement or rotation of the housing cover.

The one or more couplers may comprise one or more fasteners configured to lock the movement or rotation of the housing cover relative to the housing body in a lock state in which the one or more fasteners tighten the housing cover to the housing body and to allow the movement or rotation of the housing cover relative to the housing body in an unlock state in which the one or more fasteners do not tighten the housing cover to the housing body.

The actuator assembly may further comprise one or more slots configured to allow the housing cover to be movable or rotatable relative to the housing body such that the idler fixed to the housing cover is movable or rotatable according to the movement or rotation of the housing cover allowed by the one or more slots of the housing cover to adjust tension of the drive belt.

The actuator assembly may further comprise one or more fasteners inserted in the one or more slots of the housing cover and fixedly coupled to the housing body.

The one or more slots of the housing cover may have an elongated shape or a circumferentially curved shape.

A length of the one or more slots of the housing cover may be larger than a width of the one or more slots of the housing cover.

The actuator assembly may further comprise one or more fasteners inserted in the one or more slots of the housing cover and fixedly coupled to the housing body, each of the one or more fasteners comprising: one end portion fixedly coupled to the housing body; a middle portion disposed in a respective one of the one or more slots, wherein a width of the middle portion is equal to or shorter than a width of the respective one of the one or more elongated slots; and a projecting portion having a larger width than the width of the respective one of the one or more slots to limit movement of the housing cover between the projecting portion and the housing body.

At least a part of the one or more slots may be formed at one or more protruded portions radially protruding from a circumferential side surface of the housing cover, and the one or more protruded portions of the housing cover may be located within one or more recesses formed on a surface of the housing body such that the one or more protruded portions of the housing cover is movable or rotatable within the one or more recesses of the housing body.

The housing cover may have one or more tooling structures so that a tool for rotating the housing cover is couplable to the one or more tooling structures of the housing cover.

The one or more tooling structures of the housing cover may have one or more recesses and/or protrusions on a surface of the housing cover.

The one or more slots formed at the housing cover may comprise a pair of slots arranged at opposite sides of the housing cover with respect to the motor shaft.

The idler may comprise an idler pulley rotatably in contact with the drive belt and an idler fastener rotatably securing the idler pulley to the housing cover such that the idler pully is rotatable around the idler fastener.

According to certain embodiments of the present disclosure, an electromechanical brake system may comprise: a screw-nut mechanism comprising a rotatable body configured to be rotatable and a translatable body operably coupled with the rotatable body, the translatable body configured to be axially translatable relative to the rotatable body to move a brake pad assembly according to rotation of the rotatable body; and an actuator assembly configured to rotate the rotatable body of the screw-nut mechanism, the actuator assembly comprising: a motor having a motor shaft; and a motor housing comprising a housing body accommodating at least a part of the motor and a housing cover coupled to the housing body, wherein an idler configured to tension a drive belt rotatably coupled to the motor shaft is fixed to the housing cover having a hole for passing through the motor shaft. The electromechanical brake system may further comprise one or more couplers configured to allow the housing cover to be movable or rotatable relative to the housing body such that the idler fixed to the housing cover is movable or rotatable according to movement or rotation of the housing cover. The one or more couplers may comprise one or more fasteners configured to lock the movement or rotation of the housing cover relative to the housing body in a lock state in which the one or more fasteners tighten the housing cover to the housing body and to allow the movement or rotation of the housing cover relative to the housing body in an unlock state in which the one or more fasteners do not tighten the housing cover to the housing body.

A better understanding of the nature and advantages of the present disclosure may be gained with reference to the detailed description and the drawings below.

### BRIEF DESCRIPTION OF THE DRAWINGS

Various embodiments in accordance with the present disclosure will be described with reference to the drawings, in which:

FIG. 1 is an exploded view of an actuator assembly according to an exemplary embodiment of the present disclosure.

FIG. 2 is a perspective view of an actuator assembly according to an exemplary embodiment of the present disclosure.

FIG. 3 is a cross-sectional view of an electromechanical brake system in a vertical plane according to an exemplary embodiment of the present disclosure.

FIG. 4 is a partial cross-sectional view of an electromechanical brake system in a horizontal plane according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

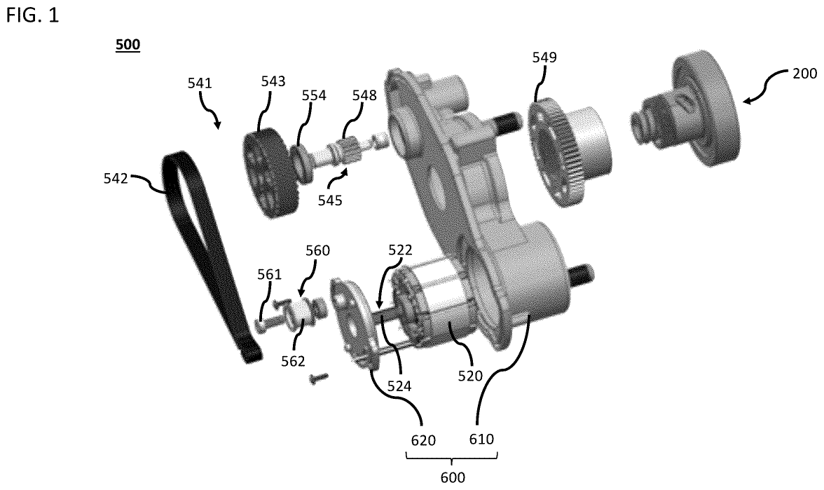

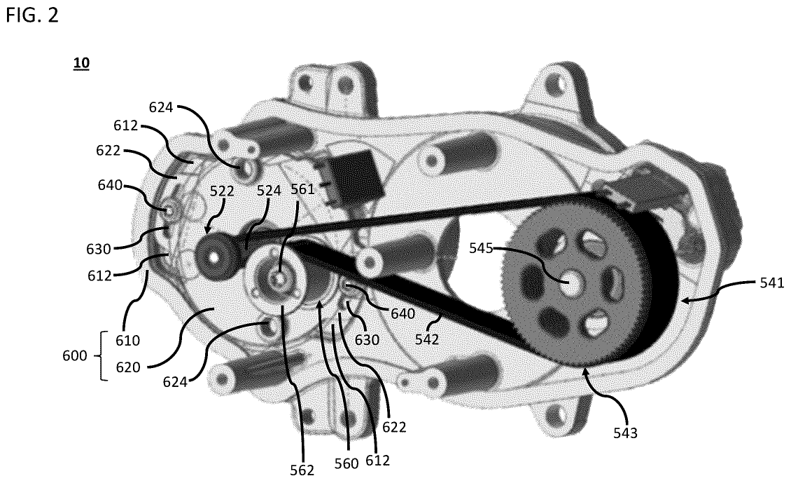

FIG. 1 is an exploded view of an actuator assembly according to an exemplary embodiment of the present disclosure. FIG. 2 is a perspective view of an actuator assembly according to an exemplary embodiment of the present disclosure.

Referring to FIGS. 1 and 2, an actuator assembly 500 may comprise a motor 520. The motor 520 may have a motor rotor shaft 522. The motor 520 may be an electric motor configured to convert electrical energy into mechanical energy by generating force in the form of rotary torque applied on the motor rotor shaft 522. The motor 520 may be electrically connected to a circuit board having memory, one or more processors, and electric components, or an electric connector via one or more electrical conductors connected to an external device. The motor 520 may be actuated and controlled by the circuit board or the external device for providing the desired rotational speed and rotational direction of the motor rotor shaft 522 of the motor 520.

The actuator assembly 500 may comprise a belt drive mechanism 541 to multiply torque from the motor 520. The belt drive mechanism 541 may comprise a drive pulley 524, a drive belt 542 and a driven pulley 543.

The drive pulley 524 may be formed directly on the motor rotor shaft 522 or attached to the motor rotor shaft 522. For example, the drive pulley 524 may be directly machined on the circumferential surface of the motor rotor shaft 522 to be coupled with the drive belt 542. In an alternative example, the drive pulley 524 may be mounted to and pressed in the motor rotor shaft 522 as a separate piece. The drive pulley 524 may be located adjacent to a distal end of the motor rotor shaft 522.

The drive pulley 524 may have an outer surface that engages an inner surface of the drive belt 542. The outer surface of the drive pulley 524 can have any suitable contour or texture to help ensure a gripping contact between the drive belt 542 and the drive pulley 524. For example, the outer surface of the toothed pulley 524 and the inner surface of the drive belt 542 can include toothed mating protrusions and/or notches formed therein. The drive pulley 524 may have alternating teeth and grooves on its outer surface to be meshed with alternating grooves and teeth formed on the inner surface of the drive belt 542.

The drive pulley 524 of the motor rotor shaft 522 and the driven pulley 543 of the belt drive mechanism 541 are rotatably connected to each other via the drive belt 542. Each of the drive pully 524 and the driven pulley 543 has an outer surface that engages an inner surface of the drive belt 542. The surfaces of the drive pulley 524 and the driven pulley 543 can have any suitable contour or texture to help ensure a gripping contact between the belt 542 and the pulleys 524, 543. For example, the surfaces of the pulleys 524 and 543 and the inner surface of the belt 542 can include toothed mating protruding and/or notches formed therein.

The drive belt 542 is fit relatively snugly about the outer circumferences of the drive pully 524 and the driven pulley 543. Thus, rotational movement of the drive pulley 524 of the motor rotor shaft 522 causes rotation of the driven pulley 543 of the belt drive mechanism 541. The diameters of the pulleys 524 and 543 can be any suitable dimension for providing any desired gear ratio, such that the rotational speed of the drive pulley 524 of the motor rotor shaft 522 is different from the rotational speed of the driven pulley 543 of the belt drive mechanism 541. The diameter of the driven pulley 543 may be greater than the diameter of the drive pulley 524 of the motor rotation shaft 522. Preferably, the reduction ratio of the belt drive mechanism 541 may be 4:1 to 10:1 to efficiently provide appropriate brake force, although not limited thereto.

The drive belt 542 may be made from any suitable material or combination of materials flexible enough to loop around the pulleys 524 and 543 and maintain engagement with the outer surfaces of the pulleys 524 and 543 during rotation thereof. The drive belt 542 may be a vee belt or a cog belt, or may be made of individual links forming a chain. The drive belt 542 may be made of an elastomeric material, and may include internal metallic reinforcing members.

The actuator assembly 500 may comprise a housing 600. The housing 600 may have an inner space for accommodating at least a part of the motor 520, and the motor 520 may be fixedly mounted in the housing 600.

The housing 600 may comprise a housing body 610 and a housing cover 620. The housing cover 620 may be coupled to one open side of the housing body 610.

An idler 560 is mounted to the housing cover 620. The idler 560 may be a belt tensioner for the drive belt 542 and be configured to tension the drive belt 542. The idler 560 is used to engage the drive belt 542 to provide appropriate tension in the drive belt 542. The idler 560 may be disposed adjacent to the drive belt 542. The idler 560 can be operatively in contact with the drive belt 542. The idler 560 may contact the drive belt 542 at a location between the drive pulley 524 and the driven pulley 543.

The idler 560 may comprise an idler fastener 561 and an idler pulley 562. The idler fastener 561 is arranged to be parallel to the motor shaft 522, and is fixedly mounted to the housing cover 620. For example, one end portion of the idler fastener 561 is fixed to the housing cover 620. The idler fastener 561 may fasten the idler pulley 562 on the housing cover 620. The idler fastener 561 rotatably secures the idler pulley 562 to the housing cover 620 such that the idler pulley 562 is rotatable around the idler fastener 561. The idler fastener 561 has, for example, but not limited to, a bolt shape having an enlarged head to limit the axial movement of the idler pulley 562 and a threaded end portion to be screwed at the housing cover 620. The idler pulley 562 is rotatably supported on the idler fastener 561 and is rotatably in contact with the drive belt 542. The idler pulley 562 presses the drive 542 to assist the orientation, routing, and/or tensioning of the drive belt 542.

The idler pulley 562 may be, for example, but not limited to, an eccentrically mounted, circular idler pulley. The eccentric idler pulley can rotate about the idler fastener 561 which is eccentrically offset from the center of the eccentric idler pulley.

To adjust a tension of the drive belt 542, the housing cover 620 can be moved or rotated relative to the housing body 610 so that the idler 560 installed on the housing cover 620 can be moved or rotated relative to the drive belt 542, the drive pulley 524 or the motor shaft 522, and/or the driven pulley 543. For this operation, an embodiment of the present disclosure may comprise one or more couplers configured to allow the housing cover 620 to be movable or rotatable relative to the housing body 610 such that the idler 560 fixed to the housing cover 620 is movable or rotatable according to movement or rotation of the housing cover 620. The coupler may comprise one or more fasteners configured to lock the movement or rotation of the housing cover 620 relative to the housing body 610 in a lock state in which the fastener tightens the housing cover 620 to the housing body 610 and to allow the movement or rotation of the housing cover 620 relative to the housing body 610 in an unlock state in which the fastener does not tighten the housing cover 620 to the housing body 610.

For example, the housing cover 620 may have one or more elongated slots 630 to allow the movement or rotation of the housing cover 620 for changing the location of the idler 560 mounted to the housing cover 620 in order to adjust the tension of the drive belt 542. For example, as shown in FIG. 2, a pair of the elongated slots 630 may be arranged at opposite sides of the housing cover 620 with respect to the motor shaft 522.

The elongated slot 630 of the housing cover 620 receives a fastener 640. The fastener 640 passes through the elongated slot 630 of the housing cover 620 and is fixedly coupled to the housing body 610. For instance, a threaded end portion of the fastener 640 passing the housing cover 620 is screwed at the housing body 610 or passes through a part of the housing body 610 and is coupled to a nut.

During an operation of adjusting the tension of the drive belt 542 by relocating the idler 560, the fastener 640 loosely fastens the housing cover 620 to the housing body 610 so that the housing cover 620 can move or rotate relative to the housing body 610 but a movement of the housing cover 620 in an axial direction of the motor 520 can be limited by the fastener 640. In other words, the fastener 640 couples the housing cover 620 to the housing body 610 in a way that is not firmly or tightly held together during the adjustment of the tension of the driving belt 542. The elongated slot 630 is configured so that the elongated slot 630 is able to travel or slide along the fastener 640, thereby being capable of moving or rotating the housing cover 620. The idler 560 mounted to the housing cover 620 is movable or rotatable according to the movement or rotation of the housing cover 620. The fastener 640 can limit the movable or rotatable range and direction of the housing cover 620 in a circumferential direction of the motor 520 for changing the location of the idler 560 as well as the axial movement of the housing cover 620 in an axial direction of the motor 520 in order to prevent the housing cover 620 from completely falling off from the housing body 610.

The housing cover 620 can be rotated or moved using a tool. The housing cover 620 has one or more tooling structures 624 such that a tool for rotating or moving the housing cover 620 can be coupled to the tooling structures 624 of the housing cover 620. For example, the tooling structure 624 of the housing cover 620 has one or more recesses and/or protrusions on a surface of the housing cover 620, and the tool for rotating or moving the housing cover 620 has a shape corresponding to the tooling structure 624 of the housing cover 620 to be coupled to the one or more recesses and/or protrusions of the tooling structure 624. For instance, the tool for rotating or moving the housing cover 620 has a pair of shafts which can be inserted into grooves or holes of the tooling structure 624 of the housing cover 620 to rotate the housing cover 620.

The elongated slot 630 may have, for example, but not limited to, a circumferentially curved shape such that the elongated slot 630 can be rotated along the fastener 640 disposed within the elongated slot 630, thereby being capable of rotating the housing cover 620 and causing the idler 560 to rotate. A length of the elongated slot 630 of the housing cover 620 may be larger than a width of the elongated slot 630 of the housing cover 620. However, the elongated slot 630 can be of any shape or size which can guide the movement or rotation of the idler 560 for the adjustment of the tension of the drive belt 542.

Further, as illustrated in FIG. 2, at least a part of the elongated slot 630 may be formed at a protruded portion 622 which radially protrudes from a circumferential side surface of the housing cover 620. For example, the housing cover 620 may comprise a pair of the protruded portions 622 protruding from opposite sides of the housing cover 620 with respect to a hole of the housing cover 620 passing for the motor shaft 522.

The housing body 610 may have one or more recesses 612 formed on an outer surface of the housing body 610 such that the protruded portion 622 of the housing cover 620 are movably or rotatably positioned in the recess 612 of the housing body 610. The protruded portions 622 of the housing cover 620 where at least a part of the elongated slots 630 is formed are movable or rotatable within the recess 612 of the housing body 610. The recess 612 of the housing body 610 can provide a space for the protruded portions 622 of the housing cover 620 to be movable or rotatable in order to move or rotate the idler 560, but the recess 612 of the housing body 610 can limit the movable range or rotatable angle of the housing cover 620 by protruded walls at ends of the recess 612.

The fastener 640 may have one end portion fixedly coupled to the housing body 610. a middle portion disposed in the elongated slot 630 of the housing cover 620, and a projecting portion having a larger width than the middle portion and the elongated slot 630 to limit the movement of the housing cover 620 between the projecting portion of the fastener 640 and the housing body 610. A width of the middle portion of the fastener 640 located within the elongated slot 630 of the housing cover 620 is equal to or shorter than a width of the elongated slot 630.

The fastener 640 may be configured to lock rotation or movement of the housing cover 620 relative to the housing body 610 in a lock state in which the fastener 640 affixes the housing cover 620 to the housing body 610 by tightening the fastener 640 (e.g. rotating the fastener 640 in a fastening direction). However, the fastener 640 may be configured to allow the rotation or movement of the housing cover 620 relative to the housing body 610 in an unlock state in which the fastener 640 does not affix the housing cover 620 to the housing body 610 by releasing the fastener 640 (e.g. rotating the fastener 640 in a releasing direction).

After the fastener 640 is tightened, the fastener 640 may aid in fixation of the housing cover 620 to the housing body 610. and the housing cover 620 may not move or rotate relative to the housing body 610.

Further, a motor position sensor 535 may be disposed in sensing relationship with the motor rotor shaft 522. For example, the motor position sensor 535 may be positioned adjacent to the distal end of the motor rotation shaft 522. The motor position sensor 535 is responsive to the rotation of the motor rotation shaft 522. For example, the motor position sensor 535 and the motor rotation shaft 522 are configured such that the motor position sensor 535 can detect the rotational speed of the motor rotation shaft 522 and/or the rotational direction of the motor rotation shaft 522. Furthermore, the motor position sensor 535 and the motor rotation shaft 522 may be configured such that the motor position sensor 535 can detect the angular position of the motor rotation shaft 522. The motor position sensor 535 may generate an output signal indicative of the detected status of the motor 520.

The motor position sensor 535 and the motor rotation shaft 522 can be any suitable device(s) for generating signal responsive to the rotation of the motor rotation shaft 522. For example, the motor position sensor 535 can be a non-contact limit switch. The motor position sensor 535 may be a Hall effect sensor. Correspondingly, the motor rotation shaft 522 may include a magnetic gradient 529 formed on a surface of the motor rotation shaft 522 defined by a plurality of alternating north and south magnetically charged elements circumferentially spaced about the circumference of the motor rotation shaft 522. The magnetically charged elements 529 of the motor rotation shaft 522 can be any suitable component or material capable of retaining a magnetic charge. The magnetically charged elements 529 of the motor rotation shaft 522 can be formed and/or mounted on the surface of the motor rotation shaft 522 or can be disposed internally in the motor rotation shaft 522. For example, the magnet 529 for sensing the motor position may be pressed on the distal end of the motor rotation shaft 522.

According to some embodiments of the present disclosure. the tension of the drive belt 542 can be adjusted by rotating the housing cover 620, to which the idler 560 is mounted, because the elongated slot 630 configured to be slidable or movable along the fastener 640 fixedly coupled to the housing body 620 is formed at the housing cover 620. Accordingly, slotted features of the housing cover 620 can enable rotation or movement of the housing cover 620 within a given degree of freedom to allow for radial position of the idler 560 fixed to the housing cover 620. By rotating the housing cover 620 using the structure of the elongated slot 630, the required tension of the drive belt 542 can be achieved because the idler 560 fixedly installed to the housing cover 620 can be rotated together with the housing cover 620 relative to the drive belt 542, the drive pulley 524 or the motor shaft 522, and/or the driven pulley 543.

According to certain embodiments of the present disclosure, by having the tooling structure 624, which is couplable with a tool for rotating or moving the housing cover 620, on the housing cover 620, the operation for adjusting the tension of the drive belt 542 can be quickly and conveniently performed by simply rotating or moving the housing cover 620 using the tool.

The exemplary embodiments of the actuator assembly 500 can be applied to any type motor assembly having a motor and a belt mechanism. For example, an electro-mechanical brake (EMB) system, an electric parking brake (EPB) system, an electronic power steering (EPS) system, and any device having a belt-type actuator with an electric motor can use the exemplary embodiments of the actuator assembly 500 described above.

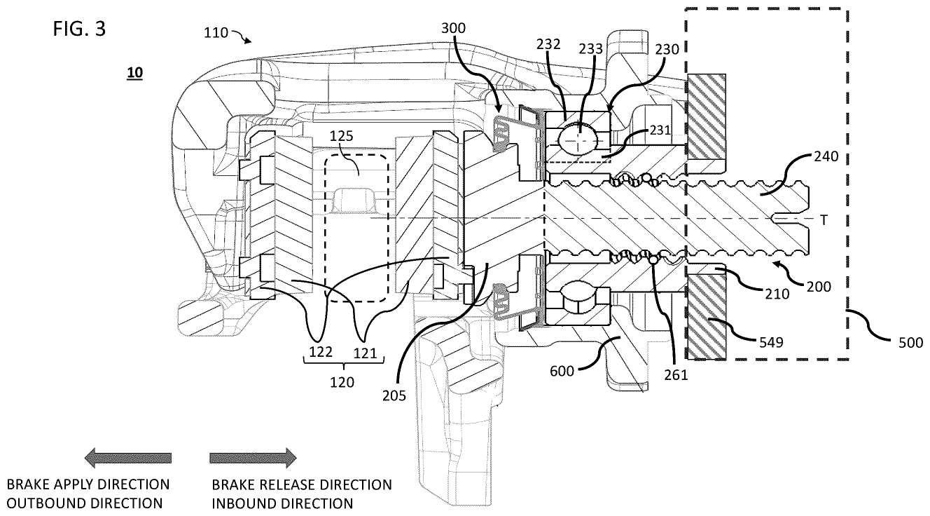

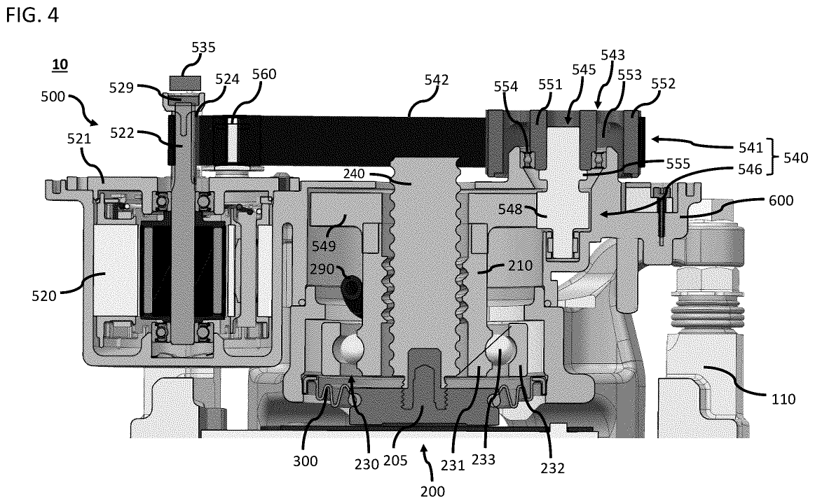

An EMB system having the actuator assembly 500 according to some embodiments of the present disclosure is described as an example with reference to FIGS. 3 and 4 together with FIGS. 1 and 2.

Referring to FIGS. 3 and 4, an electromechanical brake system 10 may include a brake caliper 110. The brake caliper 110 may be mounted in a floating manner by means of a brake carrier. The brake caliper 110 may be connected to any non-rotating or non-moving part of a vehicle. When the vehicle is in motion, a brake rotor 125 may rotate with a wheel about an axle of the vehicle. A brake pad assembly (or brake lining assembly) 120 is provided in the brake caliper 110, and includes a brake pad or lining 121 and a brake pad carrier (or a backing plate) 122. The brake caliper 110 may include a bridge with fingers, and the fingers of the brake caliper 110 may be in contact with the brake pad carrier 122. The brake pad 121 is disposed with a small air clearance on a side of the brake rotor 125, such as a brake disc, in a release position so that no significant residual drag moment occurs. The brake pad carrier 122 is disposed between the brake pad 121 and a piston or brake pad footing 205, the brake pad 121 and the brake pad carrier 122 of the brake pad assembly 120 move jointly together, and the movement of the brake pad carrier 122 causes the brake pad 121 to move with respect to the brake rotor 125.

The brake system 10 may comprise a drive mechanism 200 (e.g. a nut-screw mechanism such as a ball nut-screw mechanism) configured to convert rotary motion generated by the actuator assembly 500 into linear motion in order to move the brake pad assembly 120 toward or away from the brake rotor 125 in an axial direction.

The drive mechanism 200 may include a rotatable body 210 and a translatable body 240. For example, the rotatable body 210 may comprise a nut or a ball nut and the translatable body 240 may comprise a screw or a ball screw, although not required. The drive mechanism 200 may be contained within the housing 600. The rotatable body 210 and the translatable body 240 may be concentrically mounted in a cavity formed by an inner wall of the housing 600. The housing 600 may be fixedly coupled with the brake caliper 110.

The rotatable body 210 is operably coupled to the actuator assembly 500, and is configured to be rotatable by actuation of the actuator assembly 500 or force generated by the actuator assembly 500. For example, the rotatable body 210 is directly or indirectly coupled to the actuator assembly 500 through one or more gears and/or belts, any other connecting means and combination thereof (for example, the belt mechanism 541 and a gear mechanism 546).

The actuator assembly 500 rotates the rotatable body 210 of the drive mechanism 200, and then the drive mechanism 200 converts the rotary motion of the rotatable body 210 to the linear motion of the piston or brake pad footing 205 to move the brake pad assembly 120 between its brake apply and release positions. For example, the actuation of the actuator 500 causes the rotatable body 210 to rotate, and the rotation of the rotatable body 210 causes the translatable body 240 to be linearly moved. Specifically, the rotatable body 210 can rotate relative to the housing 600, and the rotation of the rotatable body 210 relative to the housing 600 causes the translatable body 240 to advance or retract axially depending on a direction of rotation of the rotatable body 210. As the rotatable body 210 rotates in an expanding direction, the translatable body 240 linearly translates with respect to the rotatable body 210 and the housing 600 so that the translatable body 240 can translate out from the rotatable body 210 and the housing 600 towards the brake rotor 125. As the rotatable body 210 rotates in a collapsing direction, the translatable body 240 linearly translates with respect to the rotatable body 210 and the housing 600 so that the translatable body 240 can linearly move toward the rotatable body 210 and the housing 600 in a direction away from the brake rotor 125. Preferably, the reduction ratio of the ball screw mechanism 200 (e.g. a travel distance of the screw 240/revolutions of the nut 210) may be 4 to 6 mm/rev to effectively apply or remove the brake, but not limited thereto.

The piston or brake pad footing 205 is fixedly coupled to the translatable body 240 so that the piston or brake pad footing 205 can be linearly movable together with the translatable body 240. Although FIGS. 3 and 4 illustrates that the piston or brake pad footing 205 is a separate piece from the translatable body 240 of the drive mechanism 200, the piston or brake pad footing 205 and the translatable body 240 of the drive mechanism 200 may be integrally formed as one single piece. When the drive mechanism 200 is in the expanded state, the piston or brake pad footing 205 pushes or clamps the brake pad assembly 120 toward the brake rotor 125. When the drive mechanism 200 is in the collapsed state, the piston or brake pad footing 205 moves away from the brake rotor 125.

While the expanding or collapsing direction depends upon whether the nut or ball nut of the rotatable body 210 and the screw or ball screw of the translatable body 240 are left-handed or right-handed, a specific direction is not critical to some embodiments of the present disclosure, and most embodiments of the present disclosure can work with either.

The rotatable body 210 may have a tubular shape with axially open ends, and the translatable body 240 is received within an inside space of the rotatable body 210. The rotatable body 210 and the translatable body 240 are operably connected to each other such that while the rotatable body 210 rotates, the translatable body 240 is linearly movable relative to the rotatable body 210. In other words, the translatable body 240 is slidable with respect to the rotatable body 210, but the translatable body 240 cannot be rotatable relative to the rotatable body 210, and therefore as the rotatable body 210 rotates, the translatable body 240 is linearly moved. For example, the translatable body 240 has a structure configured to prevent the translatable body 240 from rotating relative to the rotatable body 210 while allowing the translatable body 240 to translate in the axial direction.

At least a part of the translatable body 240 is retained within the rotatable body 210. The rotatable body 210 has an internally-threaded track groove and the translatable body 240 has an externally-threaded track groove for a rollable body arrangement of rollable bodies 261 (e.g. balls). The rollable bodies 261 are disposed between the internally-threaded track groove of the rotatable body 210 and the externally-threaded track groove of the translatable body 240. Ball returns either internally or externally carry the rollable bodies 261 from the end of their path back to the beginning to complete their recirculating track. A return tube 290 attached to or included in the rotatable body 210 can perform recirculation of the rollable bodies 261. The internally-threaded track groove of the rotatable body 210 and the externally-threaded track groove of the translatable body 240 can form a series of ball tracks to provide a helical raceway for reception of a train of recirculating the rollable bodies 261. The rollable bodies 261 may be metal spheres or balls which decrease friction and transfer loads between adjacent components. The rotatable body 210 is rotatably supported by the translatable body 240 via the rollable bodies 261 and a bearing assembly 230. However, in alternative embodiments of the present disclosure, the rotatable body 210 and the translatable body 240 can be directly engaged with each other without the rollable bodies 261.

The bearing assembly 230 is configured to rotatably support the drive mechanism 200 for rotation of the rotatable body 210 of the drive mechanism 200 relative to a non-rotating structure of the brake system 10, for example, but not limited to, the housing 600. And, the bearing assembly 230 is configured to transfer the axial load of clamp force to the housing 600 to react. The bearing assembly 230 may be positioned between the rotatable body 210 of the drive mechanism 200 and the non-rotating structure or housing 600. The non-rotating structure or housing 600 may cover at least a part of the bearing assembly 230 such that the bearing assembly 230 can be seated in the non-rotating structure or housing 600.

The bearing assembly 230 may have a rotatable race 231 (e.g. an inner race), a non-rotatable race 232 (e.g. an outer race or ring), and a plurality of rollable bodies 233 (e.g., bearing balls). The bearing assembly 230 may include any number of rollable bodies 233, for example, more than four balls. The non-rotatable outer race 232 may be located concentrically about the rotatable inner race 231, with the rollable bodies 233 therebetween, in a plane generally perpendicular to a rotatable axis T of the rotatable body 210 of the drive mechanism 200 or the rotatable inner bearing race 231 or a translatable axis T of the translatable body 240 of the drive mechanism 200. In an embodiment illustrated in FIGS. 3 and 4, the rotatable inner bearing race 231 is integrated with the rotatable body 210 of the drive mechanism 200 as one single piece to provide a simpler assembly process and reducing manufacturing cost, although not limited thereto. Alternatively, the rotatable inner bearing race 231 may be provided as a separate piece from the rotatable body 210 of the drive mechanism 200 and be fixedly coupled to the rotatable body 210 of the drive mechanism 200.

The specific structures of the drive mechanism 120 described above and shown in FIGS. 3 and 4 are exemplary embodiments for illustration purposes only. The present disclosure is not limited to these structures of the drive mechanism 120. Any drive mechanism having a rotatable body configured to be rotatable by the actuator assembly 500 and a linear movable body configured to be translatable according to the rotation of the rotatable body can be applied to some exemplary embodiments of the present disclosure.

The brake system 10 may further comprise a flexible boot 300. The boot 300 can provide a seal interior to the housing 600 of the brake system 10 to prevent water, dirt, and other contaminants from entering into the inside of the housing 600 of the brake system 10 (for example, an inner bore formed by an inside wall of the housing 600) and contaminating the fluid or components contained inside the housing 600 of the brake system 10. The boot 300 can serve as a cover for enclosing the interior of the inner bore of the housing 600 of the brake system 10. A plurality of flexible convolutions may be provided in a main body of the boot 300. For instance, the main body of the boot 300 can have accordion style overlapping folds that enable to expand and retract. The boot 300 may be formed from any suitable material. Preferably, the boot 300 is fabricated from a flexible material such as rubber, silicon, elastic, flexible plastic, polymer and the like so that the boot 300 can be movable, deformable, and/or pliable material without tearing or otherwise becoming damaged when a linearly movable component of the brake system 10 (e.g. the piston or brake pad footing 205 or the translatable body 240 of the drive mechanism 200) to which one end of the boot 300 is coupled moves. The boot 300 may prevent the linearly movable component of the brake system 10, to which one end of the boot 300, from rotating. The boot 300 may be designed to function as a roll back seal to retract the linearly movable component of the brake system 10 toward the inside of the inner bore of the housing 600 when the brake is released. The boot 300 may extend between the housing 600 of the brake system 10 and one of linearly movable components of the brake system 10 to provide an extensible and collapsible seal therebetween. For instance, one end of the boot 300 is coupled to the piston or brake pad footing 205 or the translatable body 240 of the drive mechanism 200 and the other end of the boot 300 is coupled to the housing 600.

Referring to FIG. 4, the actuator assembly 500 is configured to rotate the rotatable body 210 of the drive mechanism 200, such as the nut 210 of the screw-nut mechanism 200.

The driven pulley 543 of the belt-type actuator assembly 500 described above can be directly coupled to or formed on the rotatable body 210 of the drive mechanism 200 to rotate the rotatable body 210 of the drive mechanism 200.

Alternatively, as shown in FIG. 4, the actuator assembly 500 may have a multi-stage drive mechanism 540. The multi-stage drive mechanism 540 may be, for example, but not limited to, a dual-stage drive mechanism comprising the first-stage belt drive mechanism 541 and a second-stage gear assembly 546. However, the multi-stage belt drive mechanism 540 may have three or more stages of drive mechanisms. The multi-stage belt drive mechanism 540 may be configured to multiply torque from the motor 520 to supply rotary force to the rotatable body 210 of the drive mechanism 200.

The first stage belt mechanism 541 including the drive pulley 524, the driven pulley 543, and the drive belt 542 is already described above in detail.

The multi-stage drive mechanism 540 may further comprise an intermediate shaft 545 operably connecting the first-stage belt mechanism 541 to the second-stage gear mechanism 546. For example, the intermediate shaft 545 may connect the driven pulley 543 of the first-stage belt mechanism 541 to a first gear 548 of the second-stage gear assembly 546 in order to deliver rotary torque, generated by the motor 520 and transmitted through the first-stage belt drive mechanism 541, to the second-stage gear mechanism 546. The diameters of the driven pulley 543 of the first-stage belt mechanism 541 and the first gear 548 of the second-stage gear mechanism 246 may be any suitable dimension for providing the optimized reduction ratio and motor output torque. For example, the diameter of the driven pulley 543 of the first-stage belt mechanism 541 may be larger than the diameter of the first gear 548 of the second-stage gear mechanism 546 to multiply the torque transmitted from the first-stage belt mechanism 541. The intermediate shaft 545 may be positioned substantially axially parallel to the motor rotor shaft 522 to reduce the package size of the actuator assembly 500, however the orientation of the intermediate shaft 545 may be altered. The translatable body 240 of the screw-nut mechanism 200 may be arranged between the motor 520 and the intermediate shaft 545 to efficiently use the inside space of the housing 600.

The intermediate shaft 545 has a first portion where the driven pulley 243 of the first-stage belt mechanism 541 is provided and a second portion where the first gear 548 of the second-stage gear mechanism 546 is provided. The driven pulley 543 and/or the first gear 548 may be directly or integrally formed on the outer circumferential surface of the intermediate shaft 545 as one single piece by a machining or molding process. Alternatively, the driven pulley 243 and/or the first gear 548 may be assembled and fixed to the intermediate shaft 545 as a separate piece.

In operation, the first stage belt mechanism 541 multiplies the torque from the motor 520 by using the drive pully 524 and the driven pulley 543 of the first-stage belt mechanism 541 rotatably connected by the drive belt 542, and the torque multiplied by the first-stage belt mechanism 541 is delivered to the second-stage gear mechanism 546 through the intermediate shaft 545.

The driven pulley 543 provided on the intermediate shaft 545 has an inner wall 551 fixedly coupled to the intermediate shaft 545, an outer wall 552 having an outer surface rotatably engaged with the drive belt 542, and a space 553 between the inner wall 551 and the outer wall 552. One or more bearings 554 configured to rotatably support the inner wall 551 of the driven pulley 543 may be disposed inside the space 553 formed between the inner wall 551 and the outer wall 552 of the driven pulley 543 to efficiently use the inner space of the housing of the actuator assembly 500 and reduce the package size of the actuator assembly 500. The outer race of the bearing 554 is formed on or fixed to the housing 600, and the inner race of bearing 554 is fixedly coupled to the inner wall 551 of the driven pulley 543. A part of the housing 600 may protrude toward the inner space 553 of the driven pulley 543 to accommodate the bearing 554 therein.

The intermediate shaft 545 may have a flange 555 protruding radially from an outer circumferential surface of the intermediate shaft 545 to support at least a part of one side of the driven pulley 543 of the first-stage belt mechanism 541 fixedly coupled to the intermediate shaft 545.

The multi-stage drive mechanism 540 may further include the second-stage gear mechanism 546. The second-stage gear mechanism 546 may comprise the first gear 548 and a second gear 549. The second-stage gear mechanism 546 may be configured to further multiply the torque delivered from the first-stage belt mechanism 541 and provide the multiplied rotary torque to the rotatable body 210 of the drive mechanism 200, such as the nut 210 of the screw-nut mechanism 200. Preferably, the reduction ratio of the second-stage gear mechanism 541 may be 4:1 to 8:1 to efficiently provide appropriate brake force, although not limited thereto.

The first gear 548 may be formed directly on the intermediate shaft 545 or mounted to the intermediate shaft 545. For example, the tooth of the first gear 548 may be directly machined or molded on the circumferential surface of the intermediate shaft 545 to be engaged with the second gear 549. Alternatively, the first gear 548 may be mounted to and pressed in the intermediate shaft 545 as a separate piece.

The second gear 549 is rotatably engaged with the first gear 547. The second gear 549 may be formed directly on a part of the circumferential surface of the rotatable body or nut 210 of the drive mechanism or screw-nut mechanism 200, or be mounted to the rotatable body 210 of the drive mechanism 200. For example, the tooth of the second gear 549 may be directly machined or molded on the outer circumferential surface of the rotatable body 210 of the drive mechanism 200 to have toothed mating protrusions and/or notches formed thereon. Alternatively, the second gear 549 may be fixedly mounted to the rotatable body 210 of the drive mechanism 200 as a separate piece as shown in FIGS. 3 and 4.

The rotary torque by the second gear 549 for rotating the rotatable body 210 of the drive mechanism 200 may be adjusted or scalable depending on the specific force torque requirements by varying the torque of the motor 520, the diameters of the pulleys 524 and 543 and the gears 548 and 549, and/or the belt and gear reduction ratios.

According to some embodiments of the present disclosure, the multi-stage drive mechanism 540 may improve mechanical efficiency as well as reduce the packaging size and mass. Furthermore, the first-stage belt drive mechanism 541 may reduce operational noise. Additionally, according to certain embodiments of the present disclosure, the multi-stage drive mechanism 540 can produce high axial clamping brake force by at least one belt mechanism and at least one gear mechanism in the multi-stage drive mechanism 540. Further, the motor torque can be multiplied by high efficiency by the first-stage belt mechanism 541 and the second-stage gear mechanism 546. In addition, by the multi-stage drive mechanism 540 including the first-stage belt mechanism 541 and the second-stage gear mechanism 546, the axial packing space of the brake system 10 can be reduced.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An actuator assembly comprising:
a motor having a motor shaft; and
a motor housing comprising a housing body accommodating at least a part of the motor and a housing cover coupled to the housing body, wherein an idler configured to tension a drive belt rotatably coupled to the motor shaft is fixed to the housing cover having a hole for passing through the motor shaft.

2. The actuator assembly of claim 1, further comprising one or more couplers configured to allow the housing cover to be movable or rotatable relative to the housing body such that the idler fixed to the housing cover is movable or rotatable according to movement or rotation of the housing cover.

3. The actuator assembly of claim 2, wherein the one or more couplers comprise one or more fasteners configured to lock the movement or rotation of the housing cover relative to the housing body in a lock state in which the one or more fasteners tighten the housing cover to the housing body and to allow the movement or rotation of the housing cover relative to the housing body in an unlock state in which the one or more fasteners do not tighten the housing cover to the housing body.

4. The actuator assembly of claim 1, further comprising one or more slots configured to allow the housing cover to be movable or rotatable relative to the housing body such that the idler fixed to the housing cover is movable or rotatable according to the movement or rotation of the housing cover allowed by the one or more slots of the housing cover to adjust tension of the drive belt.

5. The actuator assembly of claim 4, further comprising one or more fasteners inserted in the one or more slots of the housing cover and fixedly coupled to the housing body.

6. The actuator assembly of claim 4, wherein the one or more slots of the housing cover have a circumferentially elongated shape.

7. The actuator assembly of claim 4, wherein a length of the one or more slots of the housing cover is larger than a width of the one or more slots of the housing cover.

8. The actuator assembly of claim 4, further comprising one or more fasteners inserted in the one or more slots of the housing cover and fixedly coupled to the housing body, each of the one or more fasteners comprising:
one end portion fixedly coupled to the housing body;
a middle portion disposed in a respective one of the one or more slots, wherein a width of the middle portion is equal to or shorter than a width of the respective one of the one or more slots; and
a projecting portion having a larger width than the width of the respective one of the one or more slots to limit movement of the housing cover between the projecting portion and the housing body.

9. The actuator assembly of claim 4, wherein:
at least a part of the one or more slots is formed at one or more protruded portions radially protruding from a circumferential side surface of the housing cover, and
the one or more protruded portions of the housing cover are located within one or more recesses formed on a surface of the housing body such that the one or more protruded portions of the housing cover is movable or rotatable within the one or more recesses of the housing body.

10. The actuator assembly of claim 2, wherein the housing cover has one or more tooling structures so that a tool for rotating the housing cover is couplable to the one or more tooling structures of the housing cover.

11. The actuator assembly of claim 10, wherein the one or more tooling structures of the housing cover have one or more recesses and/or protrusions on a surface of the housing cover.

12. The actuator assembly of claim 4, wherein the one or more slots formed at the housing cover comprise a pair of slots arranged at opposite sides of the housing cover with respect to the motor shaft.

13. The actuator assembly of claim 1, wherein the idler comprises an idler pulley rotatably in contact with the drive belt and an idler fastener rotatably securing the idler pulley to the housing cover such that the idler pully is rotatable around the idler fastener.

14. An electromechanical brake system comprising:
a screw-nut mechanism comprising a rotatable body configured to be rotatable and a translatable body operably coupled with the rotatable body, the translatable body configured to be axially translatable relative to the rotatable body to move a brake pad assembly according to rotation of the rotatable body; and
an actuator assembly configured to rotate the rotatable body of the screw-nut mechanism, the actuator assembly comprising:
a motor having a motor shaft; and
a motor housing comprising a housing body accommodating at least a part of the motor and a housing cover coupled to the housing body, wherein an idler configured to tension a drive belt rotatably coupled to the motor shaft is fixed to the housing cover having a hole for passing through the motor shaft.

15. The electromechanical brake system of claim 14, further comprising one or more couplers configured to allow the housing cover to be movable or rotatable relative to the housing body such that the idler fixed to the housing cover is movable or rotatable according to movement or rotation of the housing cover.

16. The electromechanical brake system of claim 15, wherein the one or more couplers comprise one or more fasteners configured to lock the movement or rotation of the housing cover relative to the housing body in a lock state in which the one or more fasteners tighten the housing cover to the housing body and to allow the movement or rotation of the housing cover relative to the housing body in an unlock state in which the one or more fasteners do not tighten the housing cover to the housing body.

17. The electromechanical brake system of claim 14, further comprising one or more slots configured to allow the housing cover to be movable or rotatable relative to the housing body such that the idler fixed to the housing cover is movable or rotatable according to the movement or rotation of the housing cover allowed by the one or more slots of the housing cover to adjust tension of the drive belt.

18. The electromechanical brake system of claim 17, further comprising one or more fasteners inserted in the one or more slots of the housing cover and fixedly coupled to the housing body.

19. The electromechanical brake system of claim 17, wherein:
at least a part of the one or more slots is formed at one or more protruded portions radially protruding from a circumferential side surface of the housing cover, and
the one or more protruded portions of the housing cover are located within one or more recesses formed on a surface of the housing body such that the one or more protruded portions of the housing cover is movable or rotatable within the one or more recesses of the housing body.

20. The electromechanical brake system of claim 15, wherein the housing cover has one or more tooling structures so that a tool for rotating the housing cover is couplable to the one or more tooling structures of the housing cover.
